(19) United States
(12) Patent Application Publication
(10) Pub. No.: US 2010/0239893 A1
(43) Pub. Date: Sep. 23, 2010

(54) SODIUM-SULFUR BATTERY WITH A SUBSTANTIALLY NON-POROUS MEMBRANE AND ENHANCED CATHODE UTILIZATION

(76) Inventors: John Howard Gordon, Salt Lake City, UT (US); John Joseph Watkins, West Jordan, UT (US)

Correspondence Address: CERAMATEC, INC., 2425 SOUTH 900 WEST, SALT LAKE CITY, UT, 84119, US

(21) Appl. No.: 12/725,319

(22) Filed: Mar. 16, 2010

Related U.S. Application Data
(63) Continuation of application No. 12/205,759, filed on Sep. 5, 2008.
(60) Provisional application No. 61/160,621, filed on Mar. 16, 2009.
(60) Provisional application No. 60/970,178, filed on Sep. 5, 2007.

(51) Int. Cl. H01M 10/44; H01M 4/58

(52) U.S. Cl. 429/50; 429/218.1

(57) ABSTRACT

A sodium-sulfur battery is disclosed in one embodiment of the invention as including an anode containing sodium and a cathode comprising elemental sulfur. The cathode may include at least one solvent selected to at least partially dissolve the elemental sulfur and Na₂Sₓ. A substantially non-porous sodium-ion-conductive membrane is provided between the anode and the cathode to keep sulfur or other reactive species from migrating therebetween. In certain embodiments, the sodium-sulfur battery may include a separator between the anode and the non-porous sodium-ion-conductive membrane. This separator may prevent the sodium in the anode from reacting with the non-porous sodium-ion-conductive membrane. In certain embodiments, the separator is a porous separator infiltrated with a sodium-ion-conductive electrolyte.

### RELATED APPLICATIONS

This application claims priority to U.S. Provisional Patent No. 61/160,621 filed on Mar. 16, 2009 and titled Sodium-Sulfur Battery With A Substantially Non-Porous Membrane and Enhanced Cathode Utilization. This application is also a continuation of, and claims priority to, U.S. application Ser. No. 12/205,759 filed on Sep. 5, 2008 and titled Lithium-Sulfur Battery With A Substantially Non-Porous Membrane And Enhanced Cathode Utilization, which claimed priority to U.S. Provisional Patent No. 60/970,178 filed on Sep. 5, 2007 and titled High Rate Lithium-Sulfur Battery With Non-Porous Ceramic Separator. These applications are hereby incorporated by reference.

### BACKGROUND OF THE INVENTION

1. Field of the Invention

This invention relates to batteries and more particularly to apparatus and methods for improving the performance of sodium-sulfur batteries.

2. Description of the Related Art

Our society has come to rely on batteries to power a myriad of devices, including computers, cell phones, portable music players, lighting devices, as well as many other electronic components. Nevertheless, there is an ongoing need for further advances in battery technology. For example, there is still a significant need for economical batteries that can power automobiles or provide load-leveling capabilities for wind, solar, or other energy technologies. Furthermore, the “information age” increasingly demands portable energy sources that provide lighter weight, higher energy, longer discharge times, more “cycles”, and smaller customized designs. To achieve these advances, technologists continue to work to develop batteries with higher and higher energy densities while still providing acceptable safety, power densities, cost, and other needed characteristics.

Sodium-sulfur (Na—S) batteries offer great potential to meet many of the above-stated needs. The theoretical specific energy of sodium-sulfur batteries is 792 Wh/kg, assuming the following overall reaction:

2Na+3S→Na₂S₃

This is one of the highest known specific energies for batteries that use non-gaseous constituents. The materials needed to produce these batteries are light, energetic, inexpensive, and readily available. In contrast with most cathode materials, sulfur is relatively non-toxic, making these batteries relatively safe for human contact.

Sodium sulfur batteries have been commercialized to some extent where the battery operates at elevated temperature, >250 C and more typically 300-350 C. The batteries use a beta alumina or beta” alumina membranes which requires high temperature for good conductivity. Also the sodium anode and sulfur cathode are molten at those temperatures. Several researchers have looked at low temperature sodium sulfur using porous membrane separators. Such, rechargeable sodium-sulfur batteries have failed to achieve commercial success for several reasons. These reasons include: (1) rapid capacity fade on cycling; (2) high self-discharge; and (3) poor utilization of the cathode. The first two reasons, namely capacity fade on cycling and high self-discharge, are related. These problems primarily occur because some of the cathode constituents, namely sodium polysulfides, are soluble in typical electrolytes. When a porous or microporous separator is used, these cathode constituents tend to migrate to the anode with each cycle, resulting in irreversible capacity loss. In view of the foregoing, what is needed is a lithium-sulfur battery that has good cathode utilization while also reducing capacity fade and self-discharge.

### SUMMARY OF THE INVENTION

The invention has been developed in response to the present state of the art and, in particular, in response to the problems and needs in the art that have not yet been fully solved by currently available sodium-sulfur batteries, especially sodium sulfur batteries intended to operate at temperatures below 200 C. Accordingly, the invention has been developed to provide systems and methods to improve the performance of sodium-sulfur batteries. The features and advantages of the invention will become more fully apparent from the following description and appended claims, or may be learned by practice of the invention as set forth hereinafter.

Consistent with the foregoing and in accordance with the invention as embodied and broadly described herein, a sodium-sulfur battery is disclosed in one embodiment of the invention as including an anode containing sodium and a cathode comprising elemental sulfur. The cathode may include at least one solvent selected to at least partially dissolve the elemental sulfur and Na₂Sₓ. A substantially non-porous sodium-ion-conductive membrane is provided between the anode and the cathode to keep sulfur or other reactive species from migrating between the anode and cathode. The battery is configured to be operated at a temperature of less than about 200 degrees Celsius.

In certain embodiments, the sodium-sulfur battery includes a separator between the anode and the non-porous sodium-ion-conductive membrane. This may prevent the sodium in the anode from reacting with the non-porous sodium-ion-conductive membrane. In certain embodiments, the separator is a porous separator infiltrated with a sodium-ion-conductive electrolyte.

In selected embodiments, the non-porous sodium-ion-conductive membrane is a thin NASICON ceramic membrane. In certain embodiments, the NASICON membrane is a slightly porous structure treated with a sealer to fill any pores in the structure, thereby making the membrane substantially non-porous. In certain embodiments, a porous structural layer, such as one or more porous NASICON layers, are attached to one or more sides of the substantially non-porous sodium-ion-conductive membrane to provide support thereto.

In another embodiment, a method in accordance with the invention may include generating sodium ions at a sodium-containing anode. These sodium ions may then be transported through a substantially non-porous sodium-ion-conductive membrane to a cathode. At the cathode, the sodium ions may be reacted with elemental sulfur, which is at least partially dissolved in one or more solvents. This reaction may generate Na₂Sₓ, which may also at least partially dissolve in the one or more solvents. In selected embodiments, the method may further include separating the sodium-containing anode from the substantially non-porous sodium-ion-conductive membrane to keep the sodium-containing anode from reacting with the membrane. This may be accomplished, for example, by placing a porous separator, infiltrated with a sodium-ion-conductive electrolyte, between the sodium-containing anode and the sodium-ion-conductive membrane.

The present invention provides an improved sodium-sulfur battery that overcomes various limitations of conventional sodium-sulfur batteries. The features and advantages of the present invention will become more fully apparent from the following description and appended claims, or may be learned by practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a high-level block diagram showing one embodiment of a sodium-sulfur battery under load;

FIG. 2 is a high-level block diagram showing one embodiment of a sodium-sulfur battery during recharge;

FIG. 3 is a high-level block diagram showing one embodiment of a sodium-sulfur battery having a separator between the non-porous membrane and the sodium-containing anode;

FIG. 4 is a high-level block diagram showing another embodiment of a sodium-sulfur battery in accordance with the invention;

FIG. 5 is a perspective view of one embodiment of a sodium-sulfur battery in accordance with the invention;

FIG. 6 is a partial, cross-sectional side view of the sodium-sulfur battery of FIG. 5;

FIG. 7 is a plot showing the solid-state conductivity of one formulation of NASICON ceramic that may be used in a sodium-sulfur battery in accordance with the invention;

FIG. 8 is a plot showing the charge and discharge characteristics of one experimental sodium-sulfur cell with a substantially non-porous sodium-ion-conductive membrane; and

FIG. 9 is a plot showing the specific energy versus cycle number where the current density is varied.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

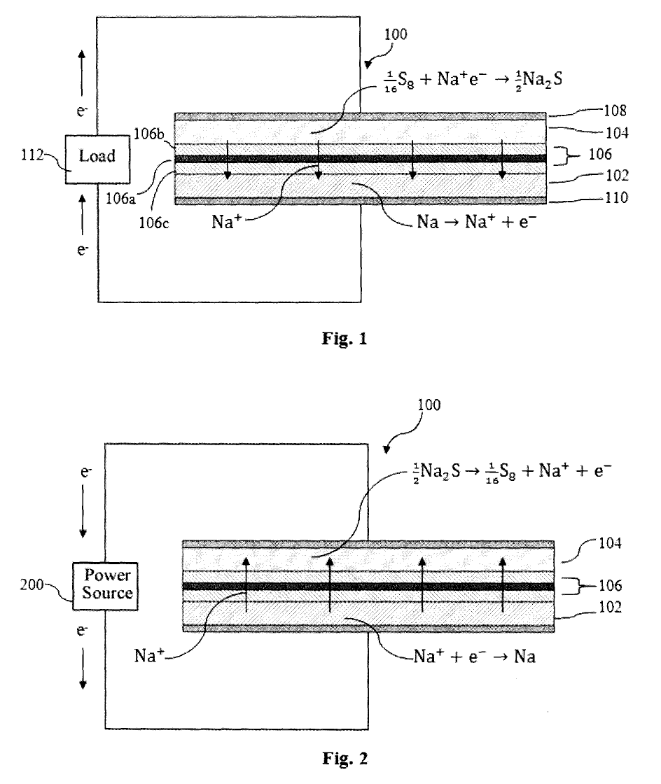

Referring to FIG. 1, one embodiment of a sodium-sulfur battery 100 under load is illustrated. In general, a sodium-sulfur battery 100 in accordance with the invention that overcomes various problems of the prior art may include a sodium-containing anode 102, a sulfur-containing cathode 104, and a substantially non-porous sodium-ion-conductive membrane 106. In this embodiment, the substantially non-porous sodium-ion conductive membrane 106 includes a thin, dense, substantially non-porous layer 106a sandwiched between or adjacent to one or more thicker, less-dense, porous layers 106b, 106c. The porous layer(s) 106b, 106c may provide mechanical support to the non-porous layer 106 in addition to allowing liquid electrolytes (e.g., the cathode and/or anode electrolytes) to permeate the pores thereof. Current collectors 108, 110, such as metal screens or meshes, may be placed in contact with or be embedded within the anode 102 and cathode 104, respectively, to conduct electrical current to and from the anode 102 and cathode 104.

In certain embodiments, the sodium-containing anode 102 may include sodium metal, a carbon matrix containing sodium metal, or other sodium-containing materials or composites. In certain embodiments, the unique design of the cell 100 may enable use of a metallic sodium anode. The safety of the metallic sodium anode 102 may be addressed in the following ways. First, the substantially non-porous membrane 106 may prevent dendritic shorts (shorts occurring when thin needle-like sodium crystals form upon recharge and penetrate a microporous separator). Second, an unreducible salt such as sodium chloride or sodium iodide may be used as an electrolyte in the anode 102 to reduce the possibility that the anode 102 will react therewith.

The cathode 104 may include elemental sulfur (typically S₈ molecules in solid form) and Na₂Sₓ (sodium monosulfide and/or polysulfide), and one or more solvents selected to at least partially dissolve the elemental sulfur and the Na₂Sₓ. The solvents may increase the mobility of the elemental sulfur and Na₂Sₓ to help them to participate more fully in the reaction occurring at the cathode. This improvement in mobility may significantly improve cathode utilization. In certain embodiments, an electronic conductor such as Super P carbon may be added to the solvents to improve the electrical conductivity of the solvent mixture.

In certain embodiments, one or more solvents may be selected to at least partially dissolve elemental sulfur and/or Na₂Sₓ. The solvents will also ideally have a relatively high boiling point. Because Na₂Sₓ is polar, in certain embodiments, a polar solvent may be selected to at least partially dissolve the Na₂Sₓ. Similarly, because elemental sulfur is apolar, an apolar solvent may be selected to at least partially dissolve the elemental sulfur. Nevertheless, in general, the solvents may include any single solvent or mixture of solvents that are effective to at least partially dissolve elemental sulfur and/or Na₂Sₓ.

For example, the instant inventors have discovered that tetraglyme (TG), a polar solvent which is useful for dissolving Na₂Sₓ, also significantly partially dissolves sulfur. Thus, tetraglyme by itself, or in combination with other polar solvents, may be used exclusively as the solvent or solvents in the cathode 104. This characteristic of tetraglyme (and possibly other polar solvents) is not believed to be disclosed in the prior art. In addition, tetraglyme is liquid over a wide temperature range, from −30 C to 275 C at 1 atmosphere pressure. The solubility characteristics of tetraglyme are especially beneficial when used with a substantially non-porous membrane 106. Other solvents that may be used in the cathode 104 may include tetrahydrafuran (THF) and/or dimethylanaline (DMA), the solubility characteristics of which are shown below in Tables 1 and 2. DMA is apolar and has been found to be particularly effective at dissolving elemental sulfur, while also having a relatively high boiling point.

TABLE 1
Sulfur Solubility in Various Solvents in Molar Percentage
Sulfur Solubility, Molar Percentage

| Solvent Mix | 25° C. | 50° C. | 70° C. |
|---|---|---|---|
| 80 TG:20 THF | 0.095 | 0.4278 | |
| 100 TG | 0.050 | 0.322 | 0.350 |
| 100 THF | 0.427 | 0.467 | |
| 100 DMA | 1.043 | 2.227 | 3.586 |
| 80 TG:20 DMA | 0.144 | 0.397 | |

TABLE 2
Sulfur Solubility in Various Solvents in Weight Percentage
Sulfur Solubility, Weight Percentage

| Solvent Mix | 25° C. | 50° C. | 70° C. |
|---|---|---|---|
| 80 TG:20 THF | 0.310 | 1.375 | |
| 100 TG | 0.159 | 1.010 | 1.097 |
| 100 THF | 1.516 | 1.658 | |
| 100 DMA | 3.366 | 6.924 | 10.692 |
| 80 TG:20 DMA | 0.459 | 1.257 | |

As described above, the battery 100 may include a substantially non-porous sodium-ion conductive membrane 106a. Unlike conventional sodium-sulfur batteries, which may use a porous membrane, the non-porous membrane 106a may prevent cathode constituents from migrating through the membrane 106 to the anode 102 where they may cause irreversible capacity loss. The substantially non-porous membrane 106a may also allow the cathode solvent mixture to be optimized to best dissolve the cathode constituents and the cathode constituents to be optimized for better rate capability and/or specific capacity. For example, by using a substantially non-porous membrane 106a, a viscous solvent or binder such as polyvinyl acetate (PVA) may become unnecessary in the cathode 104. Furthermore, by using a substantially non-porous membrane 106a, a solvent and electrolyte salt that is better suited for anode cycling performance may be used in the anode 102. In the event the substantially non-porous membrane 106a has some porosity, the pores may be filled with a sealer (e.g., a polymer) and wiped clean to prevent the migration of cathode constituents to the anode 102.

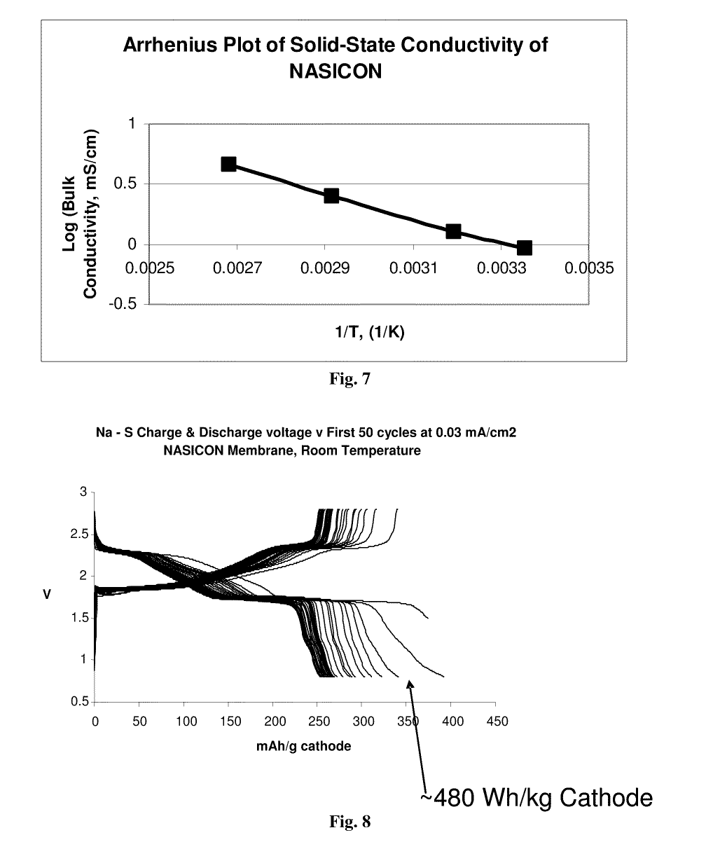

In selected embodiments, the substantially non-porous sodium-ion-conductive membrane 106 is a sodium super ionic conductor (NASICON) produced by Ceramatec, Inc. of Salt Lake City, Utah. Although not limited to this formulation, the general composition of the NASICON may be Na₁₊ₓZr₂SiₓP₃₋ₓO₁₂ where 0<x,3. Various dopants may be added to the NASICON to improve strength, conductivity, and/or sintering. The NASICON materials produced by Ceramatec exhibit good ionic conductivities at ambient temperatures. These conductivity values are higher than solid polymer electrolytes. Furthermore, the NASICON membranes 106a may be fabricated as thin as tens of microns thick with supporting porous or ribbed structures 106b, 106c to provide strength and a mechanical barrier to sodium dendrites (thin metallic crystals forming on the anode 102). The ionic conductivities of a particular NASICON formulation produced by Ceramatec are shown below in Table 3. An Arrhenius plot of the solid-state conductivity of one formulation is illustrated in FIG. 7.

TABLE 3
NASICON Conductivities at Various Temperatures

| Temp C. | mS/cm |
|---|---|
| 25 | 0.93 |
| 40 | 1.28 |
| 70 | 2.49 |
| 100 | 4.64 |

Although NASICON membranes 106a represent one candidate material that is substantially non-porous and conductive to sodium ions, the membrane 106a is not limited to this material. Indeed, any substantially non-porous sodium-ion-conductive material may be used for the membrane 106a.

Upon discharging the battery 100, sodium metal may be oxidized at the anode 102 to produce sodium ions and electrons in accordance with the following equation:

Na→Na⁺+e⁻

The electrons may be conducted through a load 112 and the sodium ions may be conducted through the membrane 106 to the cathode 104. At the cathode 104, the sodium ions may react with sulfur to form a high polysulfide (e.g., Na₂Sₓ where x=6 or 8). These high polysulfides may then be reduced to form lower polysulfides (e.g., Na₂S_{y} where y=x−2). The lower polysulfides may then be reduced further to form sodium monosulfide (Na₂S). In general, the reactions at the cathode 104 may be described by the following equations:

Initial reaction: Na⁺+x/16S₈+e⁻→1/2Na₂Sₓ, where x=4, 6, or 8

Intermediate Reaction: Na⁺+1/2Na₂Sₓ+e⁻→1/2Na₂S_{y}, where x=4, 6, or 8 and y=x−2

Final Reaction: Na⁺+1/2Na₂S₂+e⁻→Na₂S

Overall, as illustrated in FIG. 1, the reaction occurring at the cathode 104 may be generalized as follows:

Overall Reaction: 1/16S₈+Na⁺+e⁻→1/2Na₂S

Initially, as sulfur is reduced to polysulfide at the cathode 104, the cell voltage may start at about 2.5V. This voltage may drop to about 2.1V as high polysulfides are reduced to lower polysulfides. This behavior may be observed by the battery discharge characteristic illustrated in FIG. 8. As sodium monosulfide is precipitated, the cell may tend to polarize and decrease the voltage significantly. Failure to reduce Na₂S₂ to Na₂S may result in a systematic capacity loss of up to forty-one percent. Thus, it is important to select a cathode solvent that will dissolve this reaction product to some extent. By properly selecting the solvent(s), the polarization observed during formation of sodium monosulfide may be reduced or substantially avoided.

Referring to FIG. 2, upon charging, the Na₂S may be broken down at the cathode 104 to produce elemental sulfur, sodium ions, and electrons in accordance with the following equation:

1/2Na₂S→1/16S₈+Na⁺+e⁻

The electrons may be conducted through a power source 200 and the sodium ions may be conducted through the membrane 106 to the anode 102. At the anode 102, the sodium ions may react with electrons to generate sodium metal in accordance with the following equation:

Na⁺+e⁻→Na

Due to the improved mobility of elemental sulfur and Na₂Sₓ at the cathode 104, and the ability to prevent or reduce cathode constituents from migrating to the anode 102, the battery 100 may exhibit (1) reduced capacity fade on cycling; (2) reduced self-discharge; and (3) improved cathode utilization. This represents a significant improvement over conventional sodium-sulfur batteries.

Referring to FIG. 3, in selected embodiments, a sodium-sulfur battery 100 in accordance with the invention may include a separator 300 between the anode 102 and the membrane 106 to keep the sodium in the anode 102 from reacting with constituents in the membrane 106. For example, NASICON and other materials may not be completely stable when in contact with the sodium-containing anode 102. In particular, the sodium in the anode 102 may tend to react with certain constituents in formulations of NASICON, particularly titanium. Thus, apparatus and methods are needed to prevent the NASICON membrane 106 from reacting with the sodium in the anode 102.

In selected embodiments in accordance with the invention, a separator 300, such as a micro-porous separator 300 (e.g., CellGuard 2400 or 2600 or other micro-porous separator 300), may be placed between the membrane 106 and the sodium-containing anode 102. The micro-porous separator 300 may be infused (e.g., dipped, sprayed, etc.) with a solvent, such as tetraglyme, and an inorganic sodium salt such as sodium hexafluorophosphate (NaPF₆) to provide a path to conduct sodium ions between the anode 102 and the membrane 106. In general, the separator 300 may provide spatial separation between the anode 102 and the membrane 106 while still conducting sodium ions therebetween.

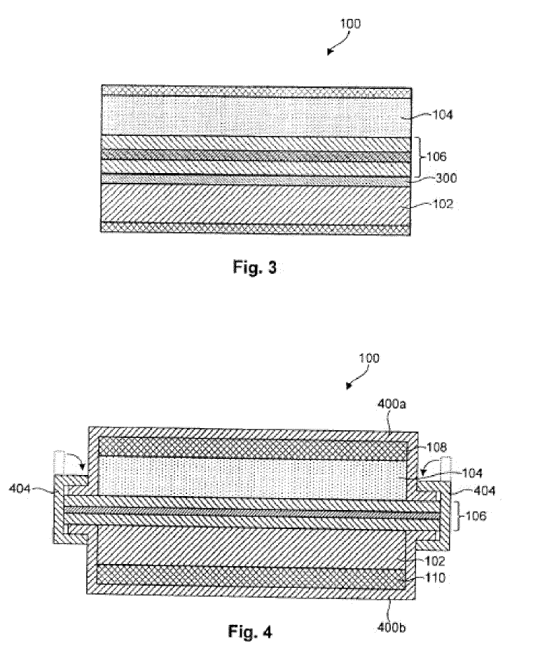

Referring to FIG. 4, in certain embodiments, a physical implementation of a sodium-sulfur battery 100 in accordance with the invention may include a housing 400 divided into two halves 400a, 400b. One half 400b may contain the sodium-containing anode 102 and a current collector 110 (e.g., a copper screen) connected to or embedded within the anode 102. The other half 400a may contain the cathode constituents 104, namely elemental sulfur and the reaction product Na₂Sₓ at least partially dissolved in a solvent. A current collector 108 (e.g., an aluminum screen) may be electrically coupled to the cathode 104. In certain embodiments, the halves 400a, 400b may be electrically conductive, thereby acting as electrodes for the battery 100. In other embodiments, the halves 400a, 400b are electrically insulating. In such embodiments, wires or other conductors may be connected to the current collectors 108, 110 to carry electrical current through the housing 400.

In certain embodiments, the substantially non-porous sodium-ion-conductive membrane 106 may be sandwiched between the two halves 400a, 400b to seal and isolate the cathode materials 104 from the anode 102. In certain embodiments, a plastic or elastomeric grommet or other suitable material may be used to seal the two halves 400a, 400b to the membrane 106. In certain embodiments, a clamping device 404, such as a clip, band, crimp, or the like, may be used to clamp the halves 400a, 400b to the membrane 106 and hold the halves 400a, 400b in place. Because all the constituents required for the battery 100 to operate may be contained within the housing 400, the battery 100 may, in certain embodiments, be a sealed system.

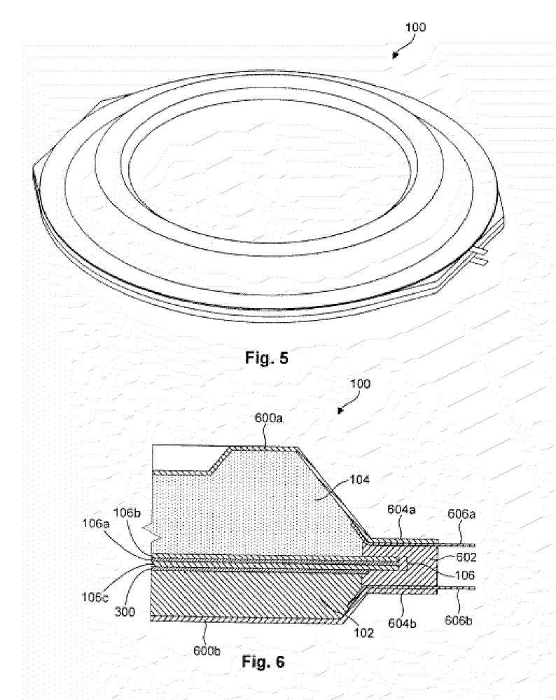

Referring to FIGS. 5 and 6, in another embodiment, a sodium-sulfur battery 100 may include a flexible, electrically-insulating outer shell or housing 600a, 600b such as a polyethylene housing 600a, 600b. Such a flexible housing 600a, 600b may tolerate volume changes encountered over a broad temperature range. Like the previous example, the housing 600a, 600b may, in selected embodiments, be divided into two halves 600a, 600b, with one half 600a housing the cathode 104 and the other half 600b housing the anode 102. The non-porous sodium-ion-conductive membrane 106, which in this example includes a dense layer 106a sandwiched between two porous layers 106b, 106c used for structural support, may separate the cathode 104 and the anode 102. In certain embodiments, a sodium-ion-conductive separator 300 may be used to spatially separate the anode 102 from the membrane 106.

In selected embodiments, an electrically insulating support ring 602, or clamp 602, such as a polyethylene or ceramic ring, may be bonded and sealed to an outer circumference of the membrane 106. This support ring 602 may then be clamped, bonded, and sealed to flanges 604a, 604b of the housing 600a, 600b to provide an effective seal with the membrane 106 and seal the cathode and anode compartments 102, 104. In certain embodiments, electrically conductive tabs 606a, 606b may be electrically connected to current collectors (not shown) which may be connected to or embedded within the anode 102 and cathode 104 respectively.

In one embodiment, a method of operating a battery according to the present invention comprises generating sodium ions at a sodium-containing anode. The sodium ions are then transported through a substantially non-porous sodium-ion-conductive membrane to a cathode where the sodium ions are reacted with elemental sulfur at the cathode to generate Na₂Sₓ. The elemental sulfur and Na₂Sₓ at least partially dissolve in at least one solvent in the cathode. The method further comprises separating the sodium-containing anode from the substantially non-porous sodium-ion-conductive membrane to keep the sodium-containing anode from reacting with the substantially non-porous sodium-ion-conductive membrane. The step of separating may include placing a porous separator between the sodium-containing anode and the substantially non-porous sodium-ion-conductive membrane. The porous separator may be permeated with a sodium-ion-conductive electrolyte. In one embodiment, the substantially non-porous sodium-ion-conductive membrane is a NASICON membrane. The pores of the NASICON membrane may be filled, either partially or completely with a sealer. The substantially non-porous sodium-ion-conductive membrane may be supported with a porous structural layer. In one embodiment, the porous structural layer is a porous NASICON layer. At least one of the solvents may include an apolar solvent to dissolve the elemental sulfur. At least one of the solvents may include a polar solvent to dissolve the Na₂Sₓ. In one embodiment, at least one solvent consists of at least one polar solvent to at least partially dissolve the elemental sulfur and the Na₂Sₓ. At least one of the solvents may comprise tetraglyme.

Referring to FIG. 8, a plot showing the charge and discharge characteristics of a sodium-sulfur cell 100 using tetraglyme as the cathode solvent is illustrated. In this example, the plot shows discharge characteristics for 50 cycles at a discharge current of 0.03 mA/cm². In this example, the cathode 104 was composed of a 60:20:20 heterogeneous blend of solid constituents, using sixty percent sulfur by weight, twenty percent conductive carbon, and twenty percent plastic binder. A 1 millimeter thick NASICON ceramic disc was used as the separator between electrodes. As can be seen from the plot, the capacity of the sodium-sulfur cell 100 decreased for the first ten cycles but then was substantially stable over the next forty cycles.

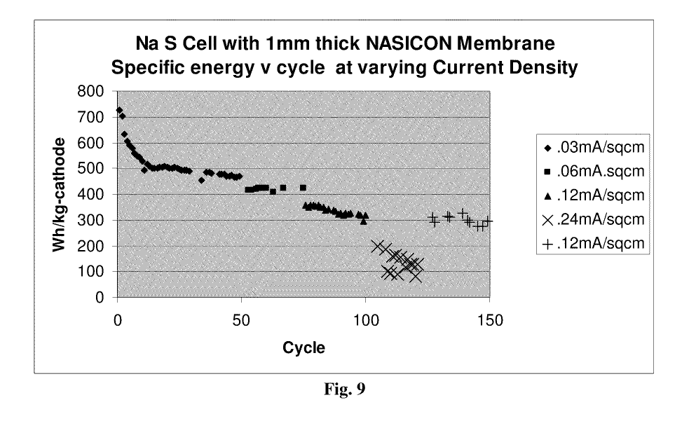

Referring to FIG. 9, characteristics of the same cell as in FIG. 8 are shown, where the cell was operated at room temperature utilizing tetraglyme as the cathode solvent and a 1 millimeter thick NASICON ceramic disc as the separator between electrodes. This plot shows specific energy verses cycle for the first 150 cycles at various charging and discharging current densities. At higher current densities the specific energy dropped in part because of the utilization of a very thick membrane, but when the current density was decreased, the specific energy rebounded, with very little cycle fading.

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. A sodium-sulfur battery comprising:
an anode containing sodium;
a cathode comprising elemental sulfur;
the cathode further comprising at least one solvent selected to at least partially dissolve the elemental sulfur and Na₂Sₓ; and
a substantially non-porous sodium-ion-conductive membrane separating the anode from the cathode,
where the battery is configured to be operated at a temperature of less than about 200° C.

2. The sodium-sulfur battery of claim 1, further comprising a separator between the anode and the substantially non-porous sodium-ion-conductive membrane to keep the anode from reacting with the substantially non-porous sodium-ion-conductive membrane.

3. The sodium-sulfur battery of claim 2, wherein the separator is a porous separator.

4. The sodium-sulfur battery of claim 3, wherein the porous separator is permeated with a sodium-ion-conductive electrolyte.

5. The sodium-sulfur battery of claim 1, wherein the substantially non-porous sodium-ion-conductive membrane is a NASICON membrane.

6. The sodium-sulfur battery of claim 1, wherein the substantially non-porous sodium-ion-conductive membrane is a NASICON membrane treated with a sealer to fill the pores thereof.

7. The sodium-sulfur battery of claim 1, further comprising a porous structural layer attached to at least one side of the substantially non-porous sodium-ion-conductive membrane to provide support thereto.

8. The sodium-sulfur battery of claim 7, wherein the porous structural layer is a porous NASICON layer.

9. The sodium-sulfur battery of claim 1, wherein the at least one solvent includes an apolar solvent to dissolve the elemental sulfur and a polar solvent to dissolve the Na₂Sₓ.

10. The sodium-sulfur battery of claim 1, wherein the at least one solvent consists of at least one polar solvent to at least partially dissolve the elemental sulfur and the Na₂Sₓ.

11. The sodium-sulfur battery of claim 1, wherein the at least one solvent consists of tetraglyme.

12. A method of operating a battery comprising:
generating sodium ions at a sodium-containing anode;
transporting the sodium ions through a substantially non-porous sodium-ion-conductive membrane to a cathode; and
reacting the sodium ions with elemental sulfur at the cathode to generate Na₂Sₓ, wherein the elemental sulfur and Na₂Sₓ at least partially dissolve in at least one solvent in the cathode.

13. The method of claim 12, further comprising separating the sodium-containing anode from the substantially non-porous sodium-ion-conductive membrane to keep the sodium-containing anode from reacting with the substantially non-porous sodium-ion-conductive membrane.

14. The method of claim 13, wherein separating comprises placing a porous separator between the sodium-containing anode and the substantially non-porous sodium-ion-conductive membrane

15. The method of claim 14, further comprising permeating the porous separator with a sodium-ion-conductive electrolyte.

16. The method of claim 12, wherein the substantially non-porous sodium-ion-conductive membrane comprises a NASICON membrane.

17. The method of claim 16, further comprising filling the pores of the NASICON membrane with a sealer.

18. The method of claim 12, further comprising supporting the substantially non-porous sodium-ion-conductive membrane with a porous structural layer.

19. The method of claim 18, wherein the porous structural layer comprises a porous NASICON layer.

20. The method of claim 12, wherein the at least one solvent comprises an apolar solvent to dissolve the elemental sulfur and a polar solvent to dissolve the Na₂Sₓ.

21. The method of claim 12, wherein the at least one solvent comprises at least one polar solvent to at least partially dissolve the elemental sulfur and the Na₂Sₓ.

22. The method of claim 12, wherein the at least one solvent comprises tetraglyme.
